(19) United States
(12) Patent Application Publication
(10) Pub. No.: US 2019/0205061 A1
(43) Pub. Date: Jul. 4, 2019

(54) PROCESSOR, METHOD, AND SYSTEM FOR REDUCING LATENCY IN ACCESSING REMOTE REGISTERS

(71) Applicant: Intel Corporation, Santa Clara, CA (US)

(72) Inventors: Eliezer Weissmann, Haifa (IL); Alexander Gendler, Kiriat Motzkin (IL); Efraim Rotem, Haifa (IL); Moshe Cohen, Zichron Yaakov (IL); Asit K. Mallick, Saratoga, CA (US); Jason W. Brandt, Austin, TX (US); Kameswar Subramaniam, Austin, TX (US); Nathan Fellman, Kiryat Motzkin (IL); Hisham Shafi, Akko (IL)

(21) Appl. No.: 15/858,878

(22) Filed: Dec. 29, 2017

(51) Int. Cl. G06F 3/06; G06F 9/30

(52) U.S. Cl. CPC G06F 3/0659; G06F 3/0611; G06F 9/45558; G06F 9/30098; G06F 3/0673

(57) ABSTRACT

Processor, method, and system for reducing latency in accessing remote registers is described herein. One embodiment of a processor includes one or more remote registers and remote register access circuitry. The remote register access circuitry is to detect a request from the requestor to access a first register of the one or more remote registers, access to the first register in accordance to the request without the requestor having to wait for completion of the access, and provide a notification accessible to the requestor upon completion of the access to the first register of the one or more remote registers.

### BACKGROUND

### Field of the Invention

The various embodiments of the invention described herein relate generally to the field of computer architecture. In particular, the disclosure relates to processor architecture and method for reducing latency in accessing remote registers.

### Description of the Related Art

A processor register or central processing unit (CPU) register is one of a small set of data-holding places that are part of the computer processor. A register may hold many kinds of data, such as an instruction or a storage (i.e., memory) address. Some registers, such as a model-specific registers (MSR), provide software applications and operating systems with the ability to control a processor's architecture and/or micro-architecture features. Some of these features include debugging, program execution tracing, and performance monitoring.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a block diagram illustrating the existing method for writing data into a register;

FIG. 2 is a block diagram illustrating an embodiment of a system in which remote register access is performed;

FIG. 3 is a block diagram illustrating a processor core embodiment;

FIG. 4 illustrates a remote register access logic in accordance with an embodiment;

FIG. 5 is a flow diagram illustrating a method embodiment for performing post-mode access;

FIG. 6 is a flow diagram illustrating a method embodiment for determining whether or not to perform remote register access in post-mode;

FIG. 7 is a flow diagram illustrating a method embodiment for writing data into a remote register in post mode;

FIG. 8 is a flow diagram illustrating a method embodiment for reading data from a remote register in post mode;

FIG. 9A is a block diagram illustrating both an exemplary in-order pipeline and an exemplary register renaming, out-of-order issue/execution pipeline according to embodiments of the invention;

FIG. 9B is a block diagram illustrating both an exemplary embodiment of an in-order architecture core and an exemplary register renaming, out-of-order issue/execution architecture core to be included in a processor according to embodiments of the invention;

FIG. 10 is a block diagram of a single core processor and a multicore processor with integrated memory controller and graphics according to embodiments of the invention;

FIG. 11 illustrates a block diagram of a system in accordance with one embodiment of the present invention;

FIG. 12 illustrates a block diagram of a second system in accordance with an embodiment of the present invention;

FIG. 13 illustrates a block diagram of a third system in accordance with an embodiment of the present invention;

FIG. 14 illustrates a block diagram of a system on a chip (SoC) in accordance with an embodiment of the present invention; and

FIG. 15 illustrates a block diagram contrasting the use of a software instruction converter to convert binary instructions in a source instruction set to binary instructions in a target instruction set according to embodiments of the invention.

### DETAILED DESCRIPTION

Embodiments of processor, method, and system for reducing latencies associated with accessing remote registers by processor cores is described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For clarity, individual components in the Figures herein may be referred to by their labels in the Figures, rather than by a particular reference number.

In computer processor architecture, a register is one of a small set of data-holding places that are part of the computer processor. A register may hold many kinds of data, such as instructions and memory addresses. Some registers, like model-specific registers (MSRs) implemented by Intel Corporation® of Santa Clara, Calif. in some of their microprocessor offerings, allow a processor's architectural and/or micro-architectural features to be controlled by software applications, operating systems, and/or virtual machines by modifying the values in these MSRs. Often times, when a software or operating system accesses a register to read or write the values in the register, the operations involved in the access are performed in a serialized manner. This means that the requestor requesting the accesses must wait until the register access is complete before it is able to move on to the next task in its execution flow.

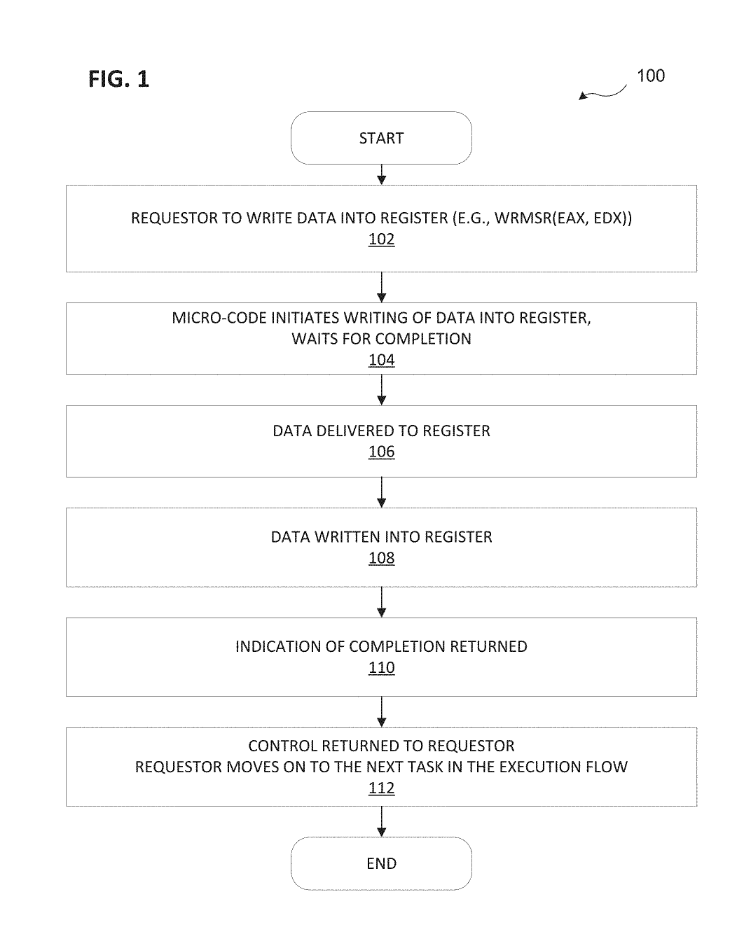

FIG. 1 is a flow diagram illustrating an existing method for writing data into a register. Method 100 begins in block 102 where a requestor, such as a software application (e.g., user-level software program), operating system, or virtual machine, intends to access a register. The requestor may write data into the register by calling or executing a write instruction, such as a WRMSR instruction for writing data to a MSR. At block 104, micro-code in the core on which the requestor is running initiates the writing of data into the register and waits for the write to complete. The register to which data is written may be located in the same core, a different core, or a location external to the core(s). The location external to the cores (i.e. off the cores) may include components shared by the cores and may be referred to as the system agent or the uncore. In block 106, data is delivered to the register. At block 108, the data is written into the register. The data delivery and writing may be performed by components in the core, by the system agent, or a combination of both. For example, the data may be delivered via a bus connecting the core and the off-core portion of the processor to a register external to the core. At block Q110, an indication of completion is returned. In one embodiment, the indication is received by the micro-code in the core. At block 112, control is returned to the requestor in response to the indication of completion. Thereafter, requestor moves on to the next task in its execution flow.

As illustrated by FIG. 1, the requestor is stalled while the access to the register is being carried out (e.g., blocks 104-110) and control is not returned to the requestor until the access is complete (e.g., block 112). Such delay in most cases is negligible because the registers being accessed are usually located within, or in close proximity, to the processor core on which the requestor (software application or operating system) is running. As such, the latency associated with register accesses tends to be low. However, for registers that are located far from the processor core, such as those located external to the processor core, in another core, or in another socket, the latency associated their access can be quite substantial. For instance, access to some registers located in locations external to the processor core can take upwards of 1500 CPU cycles. When these registers are accessed repeatedly by software applications and/or operating systems, the cumulative latency of the accesses can impose a severe negative impact on the overall performance of the processor. For example, assume that a remote register in a location external to the cores is accessed 10000 times per second, in 1GHz, the performance penalty can reach as high as 1.5% (e.g., 10000×1500/10̂9) of the overall processor performance. To address this performance issue, aspects of the present invention describe a method for short cutting the latency associated with accessing remote registers that are far from the requestor, such as MSRs located outside the processor cores. Another aspect of the present invention defines a method for the OS and/or system BIOS (basic input/output system) to specify which of the registers may utilize the method for short-cutting latency associated with accesses to remote registers.

According to an embodiment, the request from a requestor (e.g., software application or operating system) is executed without significant delay to the execution flow of the requestor because the requested data is being delivered to and from the remote register in “post-mode.” This is accomplished in two main steps. For example, for a write to a remote register, the steps include:
1^{st} Step—Requestor (e.g., software application or operating system) writes data into a local register, such as a register located in the same core on which the requestor is currently being executed (e.g., core register). The requestor then continues with its execution flow.
2^{nd} Step—Hardware internal and/or external to the core then delivers the data from the local register into the remote register.

Similarly, for reading from a remote register, the steps include:

1^{st} Step—Requestor requests data from a remote register by calling a register-read instruction. the requestor then continues with its execution flow.

2^{nd} Step—Hardware internal and/or external to the core then delivers the data from the remote register into a register local to the requestor (e.g., core register) to be accessed by the requestor.

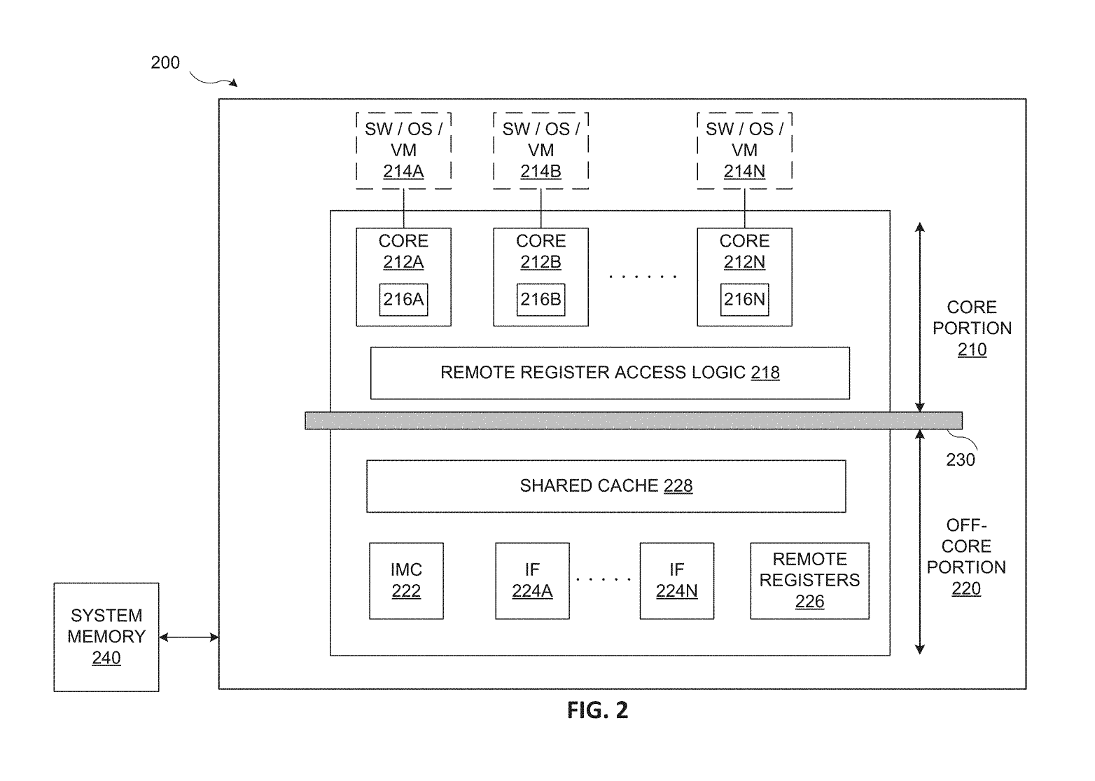

FIG. 2 is a block diagram of a processor in accordance with an embodiment of the present invention. As shown, processor 200 includes a core portion 210 and an off-core portion 220 (i.e., locations in the processor that are external to the cores). The core portion may include one or more cores 212A-212N each of which may have one or more software, operating systems, and/or virtual machines 214A-214N executing or running thereon. Each core 212A-212N may also include respective core registers 216A-216N. The core portion 210 may further include a remote register access logic 218 for carrying out register access requests from various requestors (e.g., 214A-214N). While illustrated as a single unit in FIG. 2 and separate from the cores 212A-212N, the remote register access logic 218 may alternatively be implemented in, or as part of, each of the cores 212. The remote register access logic 218 performs register access, such as read and write, on behalf of a requestor in post mode. In one embodiment, control is returned to the requestor to allow the requestor to move on to the next task in the execution flow without having to wait for the register access to complete. In one embodiment, the various components in the core portion 210 is coupled to the off-core portion 220 via an interconnect 230. The off-core portion 220, which is also known as the system agent, may further include shared cache 228 (e.g., last level cache (LLC)), integrated memory controller (IMC) 222, various interfaces 224A-224N. as well as a plurality of remote registers 226. Some of the registers 216 and 226 may be model-specific registers that are used to access architectural or micro-architectural features of the processor 200. The features may include debugging, program execution tracing, and/or performance monitoring. Processor 200 may communicate with a system memory 240 through the IMC 222 via a memory bus. In addition, through interfaces 224A-224N, connections may be made between the processor 200 and various off-chip components such as peripheral devices, mass storage, as well as other processor/chips.

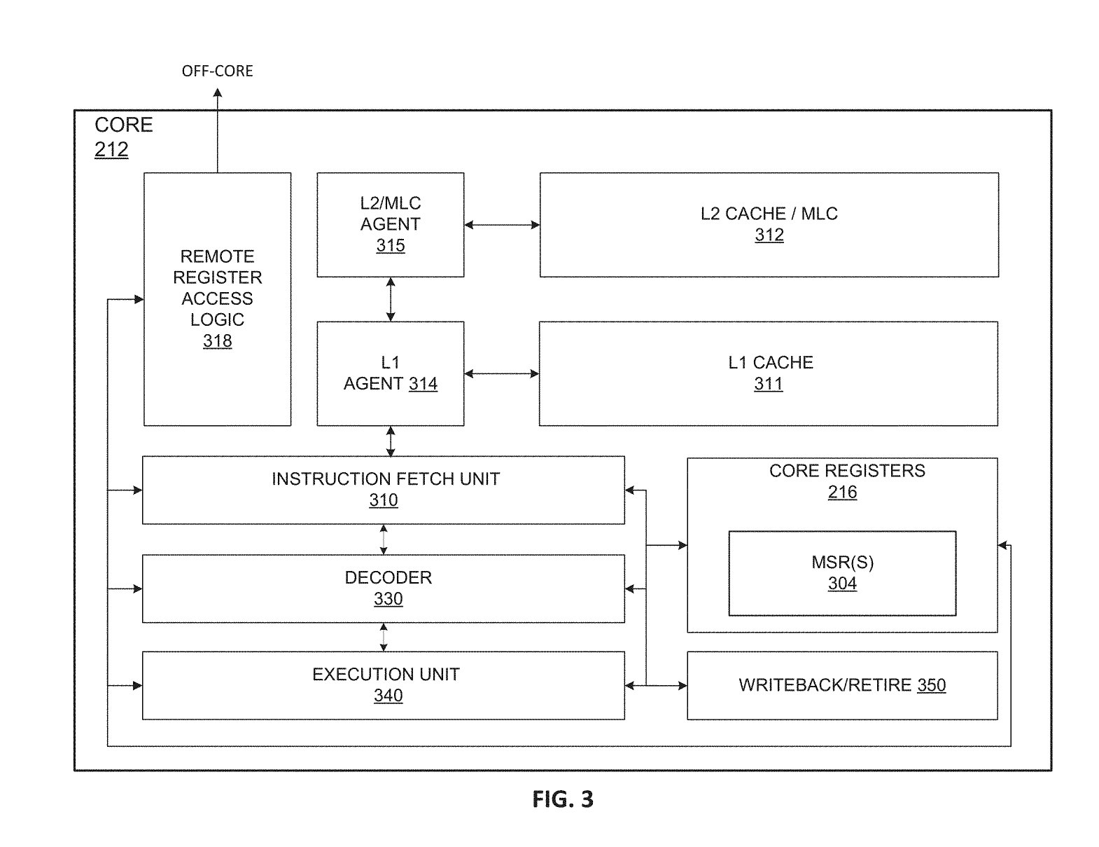

FIG. 3 illustrates an embodiment of a core (e.g., core 212 of FIG. 2) in further detail. As shown, Core 212 includes a set of core registers 216, at least some of which are model-specific register (MSRs) 304. According to an embodiment, the MSRs 304 may be accessible and/or programmable by users at boot time, such as through the Basic Input-Output System (BIOS), or at runtime, such as through the operating system (OS) and/or software applications running on the OS or on a virtual machine executed on the core. Also included in core 212 is a level 1 (L1) cache 311 and a level 2 (L2) cache 312. The L2 cache 312 may also be known as the mid-level cache (MLC). Each of L1 and L2 caches, according to an embodiment, is managed by a respective cache agent or controller (314 and 315). These caches are usable for caching instructions and data according to a specified set of cache management policies. Core 212 may include an instruction fetch unit 310 for fetching instructions from system memory (e.g., 240 of FIG. 2) and/or from one of more of the caches; a decode unit 330 for decoding the instructions (e.g., decoding program instructions into micro-operations or “uops”); an execution unit 340 for executing the decoded instructions; and a writeback unit 350 for retiring the instructions and writing back the results.

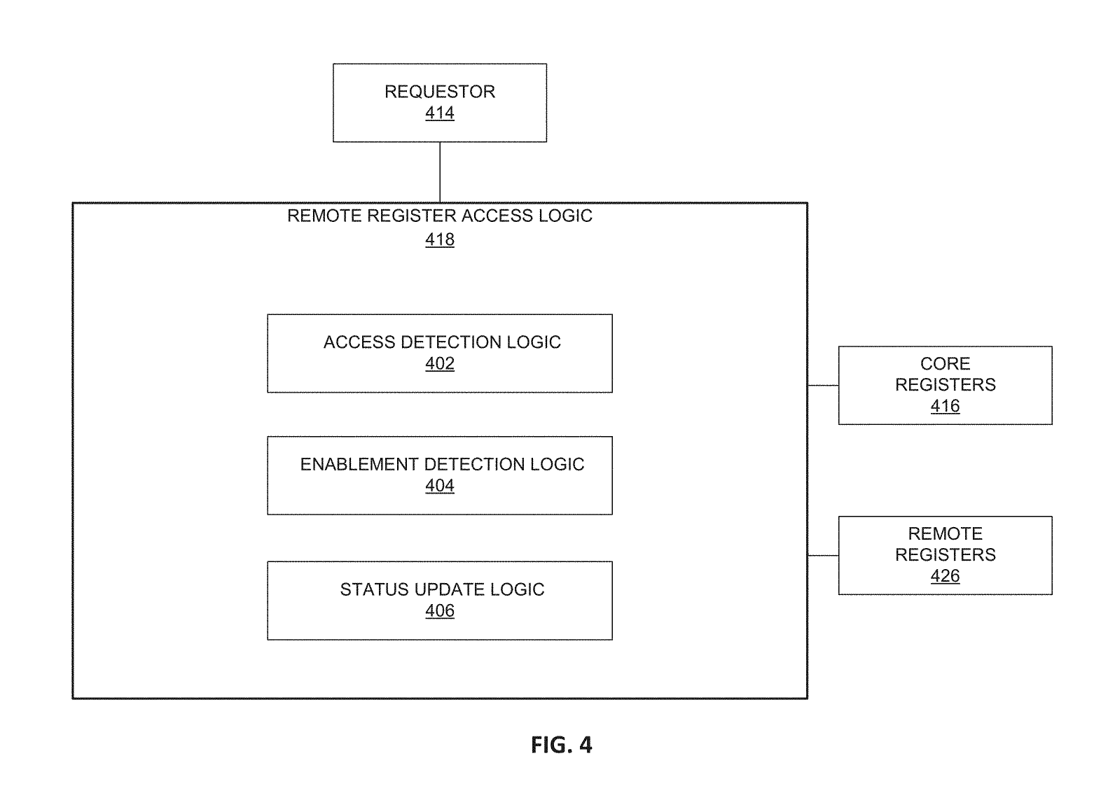

FIG. 4 is a block diagram illustrating an embodiment of a remote register access logic. As shown, the remote register access logic 418 is communicatively coupled to the requestor 414, core registers 416, and remote registers 426. The requestor 414 may be a software application (e.g., user-level software program), operating system, or virtual machine that seeks to access the core registers 416 or the remote registers 426. The requestor 414 may also be used to refer to the processor core on which these software applications, operating systems, and virtual machines are executed or running. According to an embodiment, core registers 416 refer to registers that are local to the requestor, such as registers on the same processor core as the requestor. Remote registers 426, on the other hand, refer to registers that are far from the requestor, such as those located off, or external to, the processor core on which the requestor is being executed. Both the core registers 416 and remote registers 426 may include model-specific registers.

As shown in FIG. 4, the remote register access logic 418 further includes access detection logic 402, enablement detection logic 404, and status update logic 406. The term “logic” may be used to refer to any software (program code, applications), hardware (circuits or circuitry), firmware, or a combination thereof for carrying out the intended or described function(s). For example, the access detection logic 402 includes logic for detecting accesses made by the requestor 414 to one of the core registers 416 or remote registers 426. According to an embodiment, the access detection logic 402 monitors the instructions that are being fetched, decoded, and/or executed to determine whether or not registers are accessed. For instance, a register write (e.g., WRMSR) or register read (e.g., RDMSR) instruction may indicate a register access. Alternatively, or in addition to, the access detection logic 402 may monitor specific core registers to determine whether remote registers are requested to be accessed. For instance, in writing to a remote register, data may first be written into a local register (i.e., one of core registers) before it is copied to the remote register. Thus, a write to such local register may indicate subsequent access to a remote register. In at least some embodiments, each register access instruction is associated with a register address that identifies the register to be accessed. The address of the register to be accessed may be used to determine the location of the register and/or whether the register is a local register or a remote register.

The enablement detection logic 404, in some embodiments, determines whether the register to be accessed supports post-mode access. In one embodiment, the enablement detection logic 404 may access a post-mode access capabilities register that is used for tracking the registers that support, or are capable of, post-mode access. According to the embodiment, the post-mode access capabilities register is a 64-bit core register, such as one of MSR 304 from FIG. 3. Each remote register (e.g., MSRs external to the cores) has a corresponding bit in the post-mode access capabilities register to indicate whether that register supports post-mode access. In some cases, new registers are implemented with support for post-mode access by default. These new registers would have their corresponding bits in the post-mode access capabilities register set as to indicate support for post-mode access. When post-mode access support is added to existing or legacy registers, their corresponding bit in the post-mode access capabilities register would be set to indicate this new capability. To accommodate the number of registers in the system, multiple post-mode access capabilities registers may be used. While a 64-bit MSR is described herein, it is well-understood that any appropriate length/size register may be used. According to an embodiment, the bits in the post-mode access capabilities register is set by the system BIOS as part of the BIOS run time or set by default by the manufacturer at the time of manufacture. In certain embodiments, once the bits in the post-mode access control register are set, they may be read-only to prevent tempering. According an embodiment, the requestor (i.e., software application, OS, or VM) may also access the post-mode access control register to determine whether a remote register it intends to access supports post-mode access.

In addition to post-mode access capabilities register, a post-mode access enablement register is implemented in some embodiments to give software applications, operating systems, and/or virtual machine control over whether or not to enable each register's support for post-mode access. According to an embodiment, the post-mode access enablement register is a 64-bit core register, such as one of MSR 304 from FIG. 3. Each remote register (e.g., MSRs external to the cores) has a corresponding bit in the post-mode access enablement register used for indicating whether post-mode access is enabled for that particular remote register. The bits in the post-mode access enablement register may be modified to turn on and off the support for post-mode access for each of the remote registers. In some cases, the ability to enable or disable post-mode access for a register may be restricted based on the default value of the bit for that register in the post-mode access enablement register. For example, post-mode access for a register may be changed to enabled if the default value was disabled, but not the other way around. In other words, if the default value was enabled, it cannot be changed to disabled.

According to an embodiment, a set bit (i.e., 1) in the post-mode access enablement register serves as a hint to the remote register access logic that post-mode access is enabled for the corresponding register. The bit may be sticky and is cleared only during a reset, such as a system reboot. In one embodiment, a bit in the post-mode enablement register is only taken into consideration if the corresponding remote register is capable of post-mode access support, as indicated by the corresponding bit in the post-mode access capabilities register. To accommodate the number of registers in the system, multiple post-mode access enablement registers may be used. While a 64-bit MSR is described herein, it is well-understood that any length/size register may be used.

The status update logic 406 includes logic that updates a status register responsive to result being returned from completion of post-mode access. According to the embodiment, the status register is a 64-bit core register, such as one of MSR 304 from FIG. 3. Each remote register (e.g., MSRs external to the cores) has a corresponding bit in the status register to indicate the status of the access to the remote register. For example, a set bit (i.e., “1”) indicates that the access (i.e., reading or writing data) to the corresponding remote register has yet to finish. An unset bit (i.e. “0”) indicates that the access to the corresponding remote register has completed. According to an embodiment, the bits in the status register may be accessed by the requestor to determine whether its request being performed in post-mode has been completed. In one embodiment, once the requestor determines that its access request has been completed, the requestor may access another register to get the results from the access (e.g., the results from a register read).

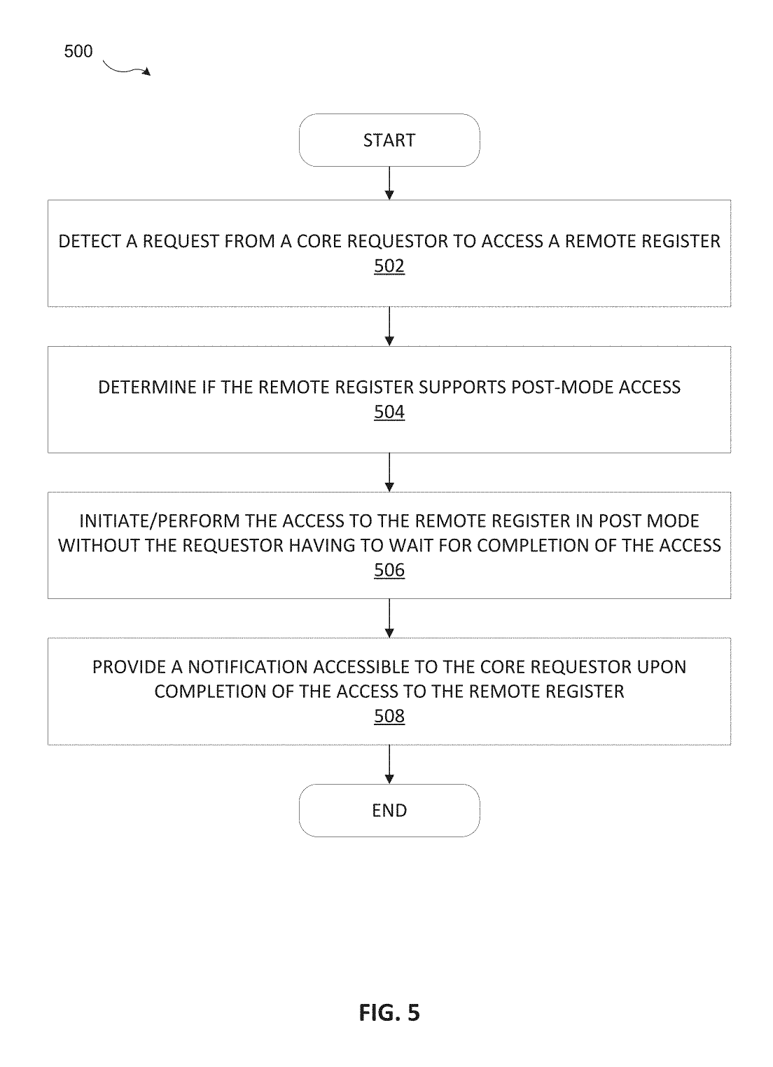

FIG. 5 is a flow diagram illustrating an embodiment of a method for performing post-mode access. The method 500 may be implemented in, or performed by, any of the hardware platform described above. In at least one embodiment, the method is performed by the remote register access logic. At block 502, a request made by a requestor (e.g., a software application (e.g., user-level software program), operating system, or virtual machine) to access a remote register is detected. The detection may be based on monitoring specific instructions (e.g., WRMSR or RDMSR) being called or executed by the requestor. Alternatively, or in addition to, the detection may be based on monitoring data being written to specific registers. According to an embodiment, the requestor is located (e.g., running or being executed) in the core portion of a processor and the remote register is located outside or external to the core portion of the processor. At block 504, the remote register access logic determines whether the remote register to be accessed supports post-mode access. The determination may be based on checking the post-mode access capabilities and/or enablement registers described above. According to an embodiment, if the remote register does not support post-mode access, then the request is performed in accordance to method 100 illustrated in FIG. 1. This means the requestor is stalled until the access is complete. On the other hand, if post-mode access is supported for the remote register, data associated with the access request is written into a core register, such as one of the MSRs 304, and the method continues on to block 504.

At block 504, the remote register access logic initiates or performs the access to the remote register in post-mode without the requestor having to wait for completion of the access. In one embodiment, the remote register access logic returns control to the requestor before the access is performed. At block 506, upon completion of the register access, the remote register access logic provides a notification accessible to the requestor. According to an embodiment, this includes updating a status register by setting or unsetting a bit that corresponds to the remote register being accessed.

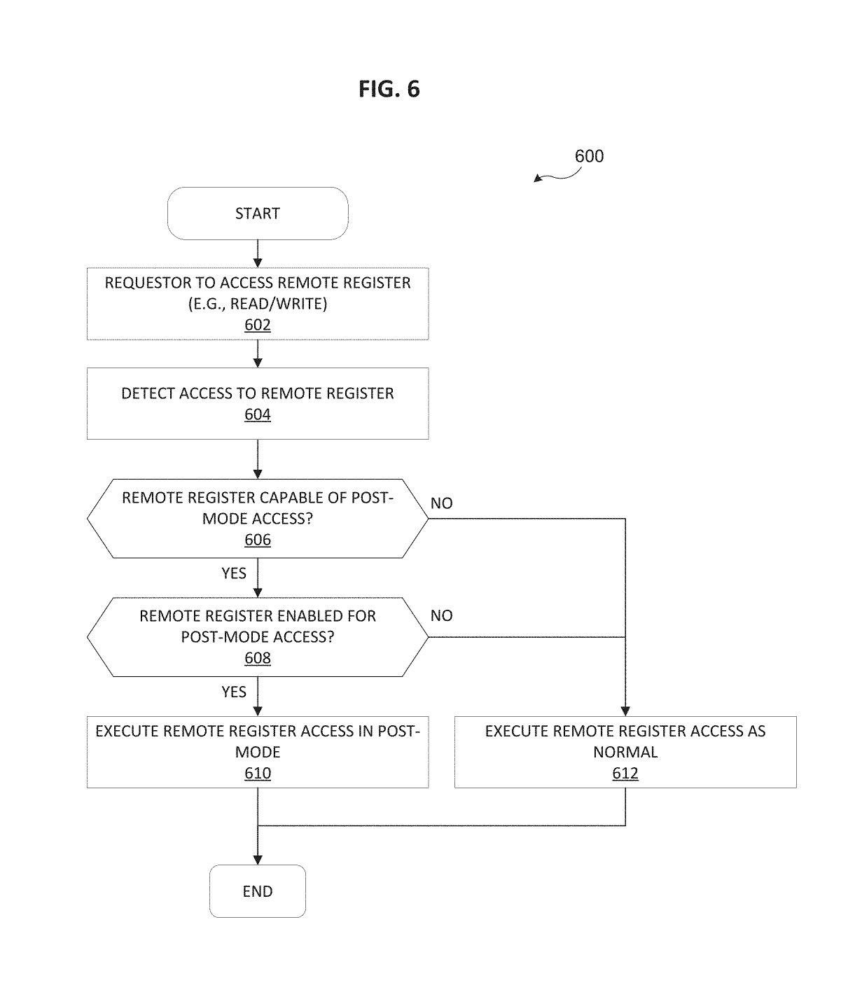

FIG. 6 is a flow diagram illustrating an embodiment of a method for determining whether or not to perform remote register access in post-mode. Unless otherwise noted, the operations of method 600 may be performed by the remote register access logic described above. At block 602, a requestor requests access to a remote register, such by calling a WRMSR instruction to write to an MSR external to the cores. At block 604, access to the remote register is detected by the access detection logic of the remote register access logic. At block 606, a determination is made as to whether or not the remote register to be accessed is capable of post-mode access. This may be performed by the enablement detection logic of the remote register access logic by checking the bit corresponding to the remote register in the post-mode capabilities register. If it is determined that the remote register is capable of post-mode access, then at block 608, the enablement detection logic further determines whether that capability is enabled by checking the corresponding bit in the post-mode enablement register. If that capability is enabled for the remote register, the access request is executed by the remote register access logic in post-mode. On the other hand, if it determined that the remote register is not capable of post-mode access at block 606 or that the such capability is not enabled at block 608, then the access request is executed as normal at block 612. This means, according to an embodiment, the access request is executed similar to method 100 illustrated in FIG. 1 where the requestor has to wait for the access to the remote register to complete before it may move on to the next task in the execution flow.

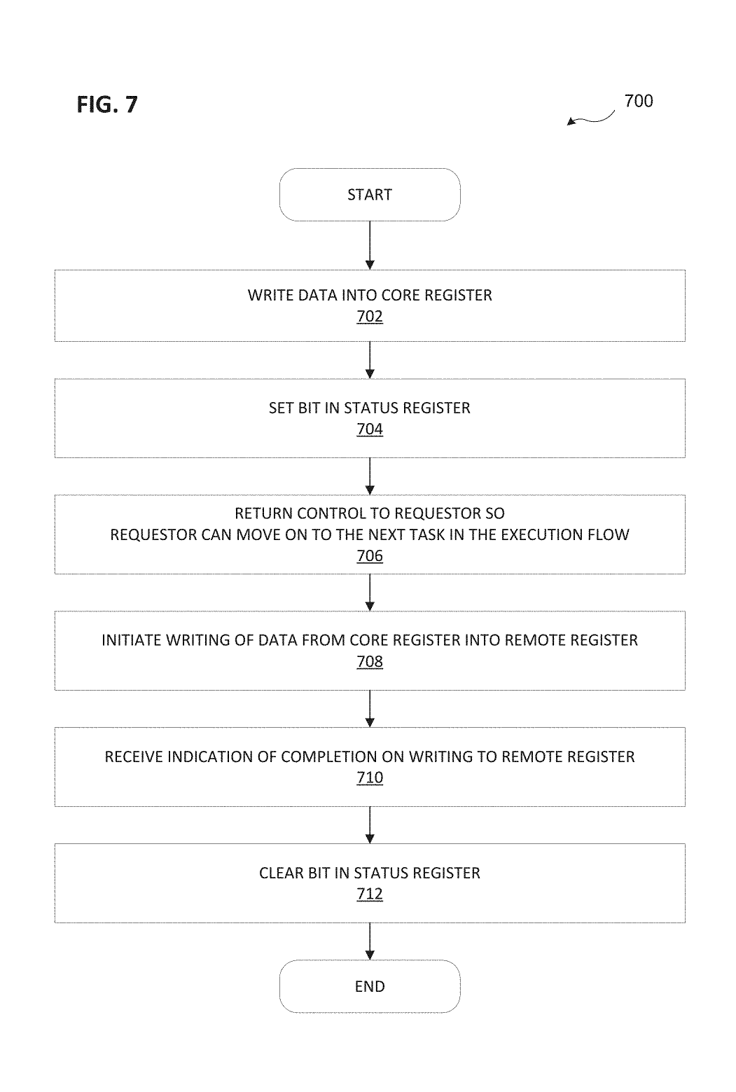

FIG. 7 is a flow diagram that illustrates an embodiment of a method for writing data into a remote register in post mode. Method 700 may be performed in, or as an extension of, block 610 from FIG. 6. Method 7 begins at block 702 in which data is written into a core register, the core register being local to the requestor requesting the write. Data may be written into the core register by micro-code on the core or by the remote register access logic. At block 704, the remote register access logic sets a bit in a status register, the bit corresponding to the remote register. At block 706, control is returned to the requestor so that the requestor can move on to the next task in the execution flow. At block 708, the remote register access logic initiates or performs the writing of data from the core register into the remote register. At block 710, an indication is returned and received by the remote register access logic which indicates that the write to the remote register is complete. At block 712, the remote register access logic clears the bit that was previously set in the status register to indicate to the requestor that the write to the remote register is complete.

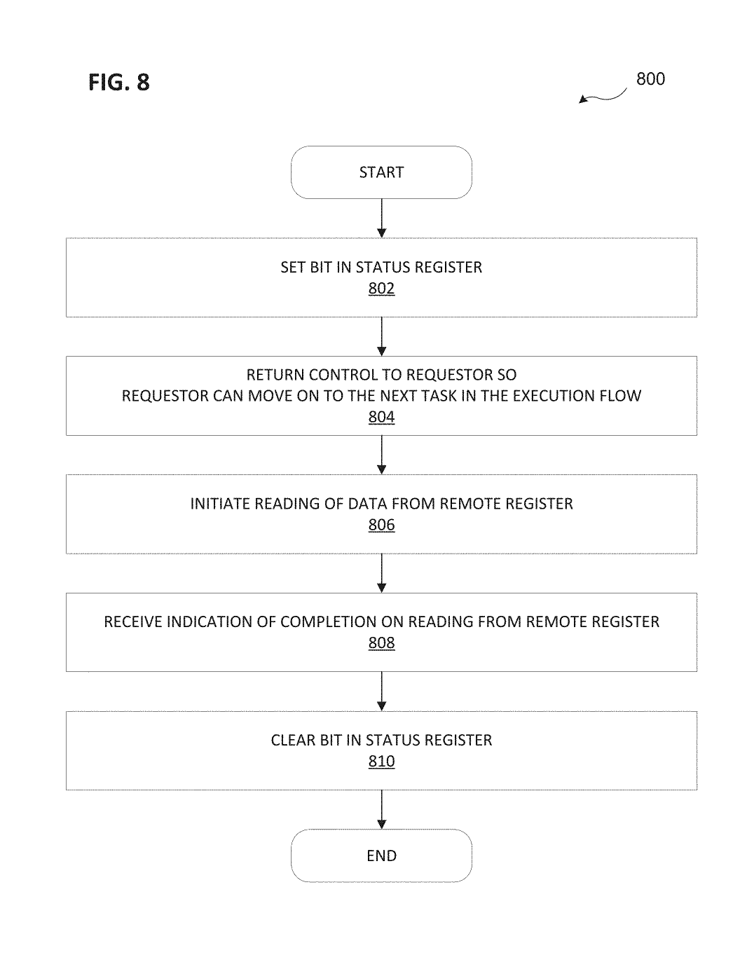

FIG. 8 is a flow diagram that illustrates an embodiment of a method for reading data from a remote register in post mode. Method 800 may be performed in, or as an extension of, block 610 from FIG. 6. Method 8 begins at block 802 in which the remote register access logic sets a bit in a status register, the bit corresponding to the remote register from which the data will be read. At block 804, control is returned to the requestor so that the requestor can move on to the next task in the execution flow. At block 806, the remote register access logic initiates or performs the reading of data from the remote register. At block 808, an indication is returned and received by the remote register access logic which indicates that the reading of data from the remote register is complete. According to an embodiment, the indication may include data read from the remote register. The data read from the remote register is stored in a core register local to the requestor to be accessed. At block 810, the remote register access logic clears the bit that was set previously in the status register to indicate to the requestor that the read to the remote register is complete.

An exemplary embodiment of the present invention is a processor that includes one or more remote registers and remote register access circuitry. The remote register access circuitry is to: detect a request from a requestor to access a first register of the one or more remote registers; access the first register in accordance to the request without the requestor having to wait for completion of the access; and provide a notification accessible to the requestor upon completion of the access to the first register of the one or more remote registers. The one or more remote registers may be model-specific registers (MSRs). The access detection circuitry may detect the request to access the first register by monitoring the processor's execution circuitry executing a register-read or a register-write instruction for reading from a MSR and writing to a MSR, respectively. The requestor may be one of a user-level software program, an operating system (OS), and a virtual machine executing on the processor. The processor may also include status update circuitry to update a status bit in a status register, wherein the status bit corresponds to the first register and is used to indicate whether the access to the first register is complete. A status bit that is set may be an indication that the access to the remote register has not yet completed whereas a status bit that is unset may be an indication that the access to the remote register is complete. When the request is a write, data may first be written into a core register local to the requestor before it is delivered to the first register.

Another embodiment of the present invention is a method that includes detecting a request from a requestor to access a first register of one or more remote registers of a processor; accessing the first register in accordance to the request without the requestor having to wait for completion of the access; and providing a notification accessible to the requestor upon completion of the access to the first register of the one or more remote registers. The one or more remote registers may be model-specific registers (MSRs). The request to access the first register maybe detected by monitoring the processor's execution circuitry executing a register-read or a register-write instruction for reading from a MSR and writing to a MSR, respectively. The requestor may be one of a user-level software program, an operating system (OS), and a virtual machine executing on the processor. The method may also include updating a status bit in a status register, wherein the status bit corresponds to the first register and is used to indicate whether the access to the first register is complete. A status bit that is set may be an indication that the access to the remote register has not yet completed whereas a status bit that is unset may be an indication that the access to the remote register is complete. When the request is a write, data may first be written into a core register local to the requestor before it is delivered to the first register.

Yet another embodiment of the present invention is a system that includes a system memory, a processor that includes one or more remote registers, and remote register access circuitry. The remote register access circuitry is to: detect a request from a requestor to access a first register of the one or more remote registers; access the first register in accordance to the request without the requestor having to wait for completion of the access; and provide a notification accessible to the requestor upon completion of the access to the first register of the one or more remote registers. The one or more remote registers may be model-specific registers (MSRs). The access detection circuitry may detect the request to access the first register by monitoring the processor's execution circuitry executing a register-read or a register-write instruction for reading from a MSR and writing to a MSR, respectively. The requestor may be one of a user-level software program, an operating system (OS), and a virtual machine executing on the processor. The system may also include status update circuitry to update a status bit in a status register, wherein the status bit corresponds to the first register and is used to indicate whether the access to the first register is complete. A status bit that is set may be an indication that the access to the remote register has not yet completed whereas a status bit that is unset may be an indication that the access to the remote register is complete. When the request is a write, data may first be written into a core register local to the requestor before it is delivered to the first register.

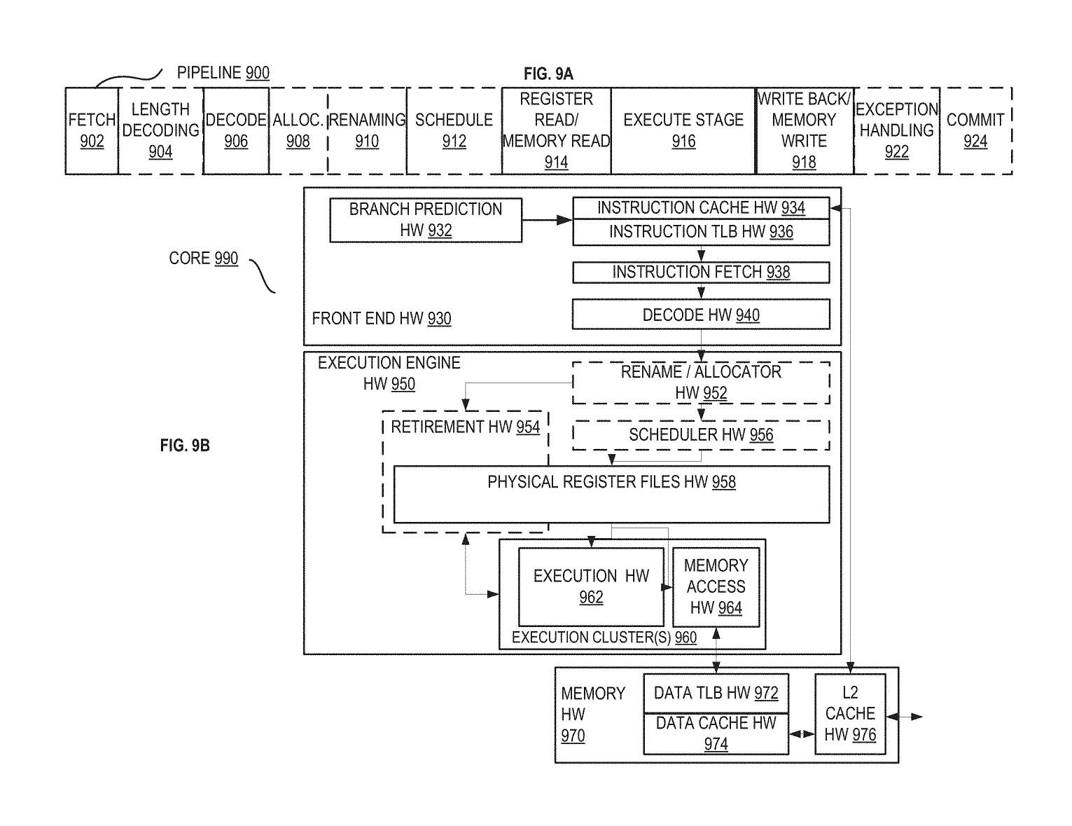

FIG. 9A is a block diagram illustrating both an exemplary in-order pipeline and an exemplary register renaming, out-of-order issue/execution pipeline according to embodiments of the invention. FIG. 9B is a block diagram illustrating both an exemplary embodiment of an in-order architecture core and an exemplary register renaming, out-of-order issue/execution architecture core to be included in a processor according to embodiments of the invention. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 9B shows processor core 990 including a front end hardware 930 coupled to an execution engine hardware 950, and both are coupled to a memory hardware 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end hardware 930 includes a branch prediction hardware 932 coupled to an instruction cache hardware 934, which is coupled to an instruction translation lookaside buffer (TLB) 936, which is coupled to an instruction fetch hardware 938, which is coupled to a decode hardware 940. The decode hardware 940 (or decoder) may decode instructions, and generate as an output one or more micro-operations, micro-code entry points, microinstructions, other instructions, or other control signals, which are decoded from, or which otherwise reflect, or are derived from, the original instructions. The decode hardware 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode hardware 940 or otherwise within the front end hardware 930). The decode hardware 940 is coupled to a rename/allocator hardware 952 in the execution engine hardware 950.

The execution engine hardware 950 includes the rename/allocator hardware 952 coupled to a retirement hardware 954 and a set of one or more scheduler hardware 956. The scheduler hardware 956 represents any number of different schedulers, including reservations stations, central instruction window, etc. The scheduler hardware 956 is coupled to the physical register file(s) hardware 958. Each of the physical register file(s) hardware 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) hardware 958 comprises a vector registers hardware, a write mask registers hardware, and a scalar registers hardware. This register hardware may provide architectural vector registers, vector mask registers, and general purpose registers. The physical register file(s) hardware 958 is overlapped by the retirement hardware 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement hardware 954 and the physical register file(s) hardware 958 are coupled to the execution cluster(s) 960. The execution cluster(s) 960 includes a set of one or more execution hardware 962 and a set of one or more memory access hardware 964. The execution hardware 962 may perform various operations (e.g., shifts, addition, subtraction, multiplication) and on various types of data (e.g., scalar floating point, packed integer, packed floating point, vector integer, vector floating point). While some embodiments may include a number of execution hardware dedicated to specific functions or sets of functions, other embodiments may include only one execution hardware or multiple execution hardware that all perform all functions. The scheduler hardware 956, physical register file(s) hardware 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler hardware, physical register file(s) hardware, and/or execution cluster—and in the case of a separate memory access pipeline, certain embodiments are implemented in which only the execution cluster of this pipeline has the memory access hardware 964). It should also be understood that where separate pipelines are used, one or more of these pipelines may be out-of-order issue/execution and the rest in-order.

The set of memory access hardware 964 is coupled to the memory hardware 970, which includes a data TLB hardware 972 coupled to a data cache hardware 974 coupled to a level 2 (L2) cache hardware 976. In one exemplary embodiment, the memory access hardware 964 may include a load hardware, a store address hardware, and a store data hardware, each of which is coupled to the data TLB hardware 972 in the memory hardware 970. The instruction cache hardware 934 is further coupled to a level 2 (L2) cache hardware 976 in the memory hardware 970. The L2 cache hardware 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode hardware 940 performs the decode stage 906; 3) the rename/allocator hardware 952 performs the allocation stage 908 and renaming stage 910; 4) the scheduler hardware 956 performs the schedule stage 912; 5) the physical register file(s) hardware 958 and the memory hardware 970 perform the register read/memory read stage 914; the execution cluster 960 perform the execute stage 916; 6) the memory hardware 970 and the physical register file(s) hardware 958 perform the write back/memory write stage 918; 7) various hardware may be involved in the exception handling stage 922; and 8) the retirement hardware 954 and the physical register file(s) hardware 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache hardware 934/974 and a shared L2 cache hardware 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

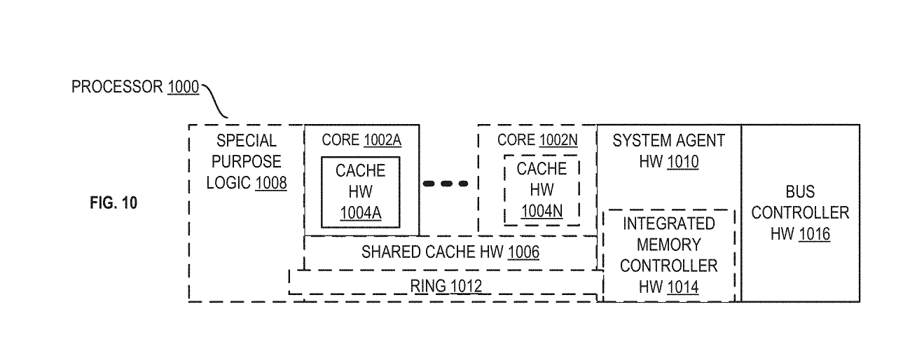

FIG. 10 is a block diagram of a processor 1000 that may have more than one core, may have an integrated memory controller, and may have integrated graphics according to embodiments of the invention. The solid lined boxes in FIG. 10 illustrate a processor 1000 with a single core 1002A, a system agent 1010, a set of one or more bus controller hardware 1016, while the optional addition of the dashed lined boxes illustrates an alternative processor 1000 with multiple cores 1002A-N, a set of one or more integrated memory controller hardware 1014 in the system agent hardware 1010, and special purpose logic 1008.

Thus, different implementations of the processor 1000 may include: 1) a CPU with the special purpose logic 1008 being integrated graphics and/or scientific (throughput) logic (which may include one or more cores), and the cores 1002A-N being one or more general purpose cores (e.g., general purpose in-order cores, general purpose out-of-order cores, a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache hardware 1006, and external memory (not shown) coupled to the set of integrated memory controller hardware 1014. The set of shared cache hardware 1006 may include one or more mid-level caches, such as level 2 (L2), level 3 (L3), level 4 (L4), or other levels of cache, a last level cache (LLC), and/or combinations thereof. While in one embodiment a ring based interconnect hardware 1012 interconnects the integrated graphics logic 1008, the set of shared cache hardware 1006, and the system agent hardware 1010/integrated memory controller hardware 1014, alternative embodiments may use any number of well-known techniques for interconnecting such hardware. In one embodiment, coherency is maintained between one or more cache hardware 1006 and cores 1002-A-N.

In some embodiments, one or more of the cores 1002A-N are capable of multi-threading. The system agent 1010 includes those components coordinating and operating cores 1002A-N. The system agent hardware 1010 may include for example a power control unit (PCU) and a display hardware. The PCU may be or include logic and components needed for regulating the power state of the cores 1002A-N and the integrated graphics logic 1008. The display hardware is for driving one or more externally connected displays.

The cores 1002A-N may be homogenous or heterogeneous in terms of architecture instruction set; that is, two or more of the cores 1002A-N may be capable of execution the same instruction set, while others may be capable of executing only a subset of that instruction set or a different instruction set. In one embodiment, the cores 1002A-N are heterogeneous and include both the “small” cores and “big” cores described below.

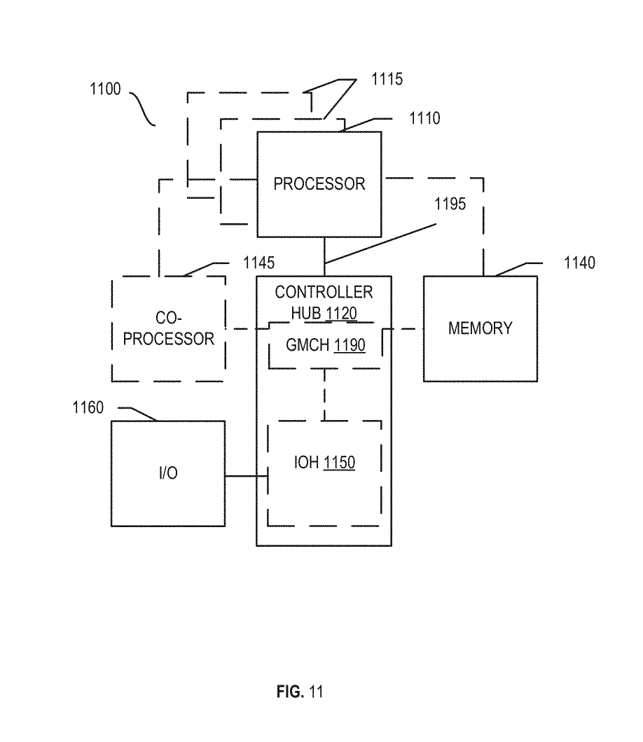

FIGS. 11-14 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1100 in accordance with one embodiment of the present invention. The system 1100 may include one or more processors 1110, 1115, which are coupled to a controller hub 1120. In one embodiment the controller hub 1120 includes a graphics memory controller hub (GMCH) 1190 and an Input/Output Hub (IOH) 1150 (which may be on separate chips); the GMCH 1190 includes memory and graphics controllers to which are coupled memory 1140 and a coprocessor 1145; the IOH 1150 is couples input/output (I/O) devices 1160 to the GMCH 1190. Alternatively, one or both of the memory and graphics controllers are integrated within the processor (as described herein), the memory 1140 and the coprocessor 1145 are coupled directly to the processor 1110, and the controller hub 1120 in a single chip with the IOH 1150.

The optional nature of additional processors 1115 is denoted in FIG. 11 with broken lines. Each processor 1110, 1115 may include one or more of the processing cores described herein and may be some version of the processor 1000.

The memory 1140 may be, for example, dynamic random access memory (DRAM), phase change memory (PCM), or a combination of the two. For at least one embodiment, the controller hub 1120 communicates with the processor(s) 1110, 1115 via a multi-drop bus, such as a frontside bus (FSB), point-to-point interface, or similar connection 1195.

In one embodiment, the coprocessor 1145 is a special-purpose processor, such as, for example, a high-throughput MIC processor, a network or communication processor, compression engine, graphics processor, GPGPU, embedded processor, or the like. In one embodiment, controller hub 1120 may include an integrated graphics accelerator.

There can be a variety of differences between the physical resources 1110, 1115 in terms of a spectrum of metrics of merit including architectural, microarchitectural, thermal, power consumption characteristics, and the like.

In one embodiment, the processor 1110 executes instructions that control data processing operations of a general type. Embedded within the instructions may be coprocessor instructions. The processor 1110 recognizes these coprocessor instructions as being of a type that should be executed by the attached coprocessor 1145. Accordingly, the processor 1110 issues these coprocessor instructions (or control signals representing coprocessor instructions) on a coprocessor bus or other interconnect, to coprocessor 1145. Coprocessor(s) 1145 accept and execute the received coprocessor instructions.

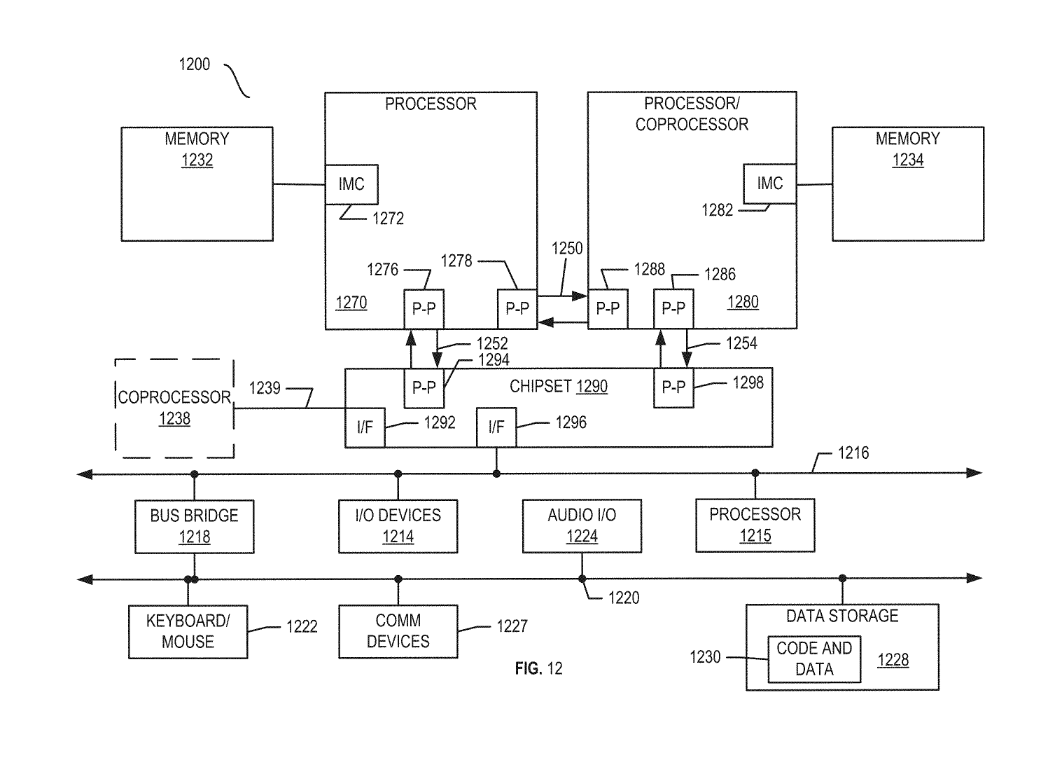

Referring now to FIG. 12, shown is a block diagram of a first more specific exemplary system 1200 in accordance with an embodiment of the present invention. As shown in FIG. 12, multiprocessor system 1200 is a point-to-point interconnect system, and includes a first processor 1270 and a second processor 1280 coupled via a point-to-point interconnect 1250. Each of processors 1270 and 1280 may be some version of the processor 1000. In one embodiment of the invention, processors 1270 and 1280 are respectively processors 1110 and 1115, while coprocessor 1238 is coprocessor 1145. In another embodiment, processors 1270 and 1280 are respectively processor 1110 coprocessor 1145.

Processors 1270 and 1280 are shown including integrated memory controller (IMC) hardware 1272 and 1282, respectively. Processor 1270 also includes as part of its bus controller hardware point-to-point (P-P) interfaces 1276 and 1278; similarly, second processor 1280 includes P-P interfaces 1286 and 1288. Processors 1270, 1280 may exchange information via a point-to-point (P-P) interface 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 may each exchange information with a chipset 1290 via individual P-P interfaces 1252, 1254 using point to point interface circuits 1276, 1294, 1286, 1298. Chipset 1290 may optionally exchange information with the coprocessor 1238 via a high-performance interface 1239. In one embodiment, the coprocessor 1238 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1290 may be coupled to a first bus 1216 via an interface 1296. In one embodiment, first bus 1216 may be a Peripheral Component Interconnect (PCI) bus, or a bus such as a PCI Express bus or another third generation I/O interconnect bus, although the scope of the present invention is not so limited.

As shown in FIG. 12, various I/O devices 1214 may be coupled to first bus 1216, along with a bus bridge 1218 which couples first bus 1216 to a second bus 1220. In one embodiment, one or more additional processor(s) 1215, such as coprocessors, high-throughput MIC processors, GPGPU's, accelerators (such as, e.g., graphics accelerators or digital signal processing (DSP) hardware), field programmable gate arrays, or any other processor, are coupled to first bus 1216. In one embodiment, second bus 1220 may be a low pin count (LPC) bus. Various devices may be coupled to a second bus 1220 including, for example, a keyboard and/or mouse 1222, communication devices 1227 and a storage hardware 1228 such as a disk drive or other mass storage device which may include instructions/code and data 1230, in one embodiment. Further, an audio I/O 1224 may be coupled to the second bus 1220. Note that other architectures are possible. For example, instead of the point-to-point architecture of FIG. 12, a system may implement a multi-drop bus or other such architecture.

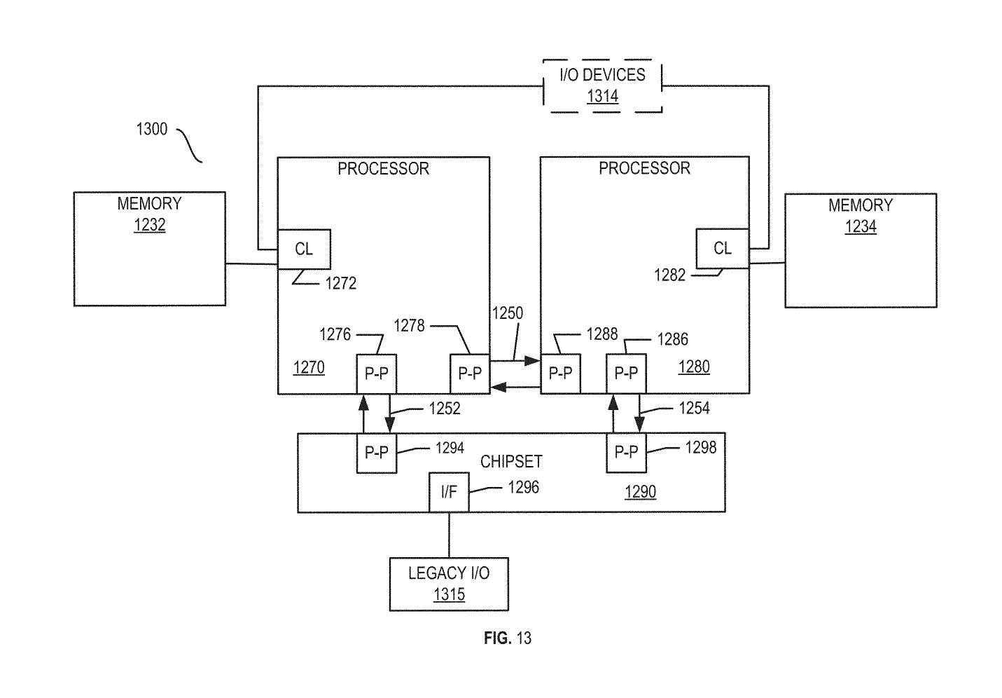

Referring now to FIG. 13, shown is a block diagram of a second more specific exemplary system 1300 in accordance with an embodiment of the present invention. Like elements in FIGS. 12 and 13 bear like reference numerals, and certain aspects of FIG. 12 have been omitted from FIG. 13 in order to avoid obscuring other aspects of FIG. 13.

FIG. 13 illustrates that the processors 1270, 1280 may include integrated memory and I/O control logic (“CL”) 1272 and 1282, respectively. Thus, the CL 1272, 1282 include integrated memory controller hardware and include I/O control logic. FIG. 13 illustrates that not only are the memories 1232, 1234 coupled to the CL 1272, 1282, but also that I/O devices 1314 are also coupled to the control logic 1272, 1282. Legacy I/O devices 1315 are coupled to the chipset 1290.

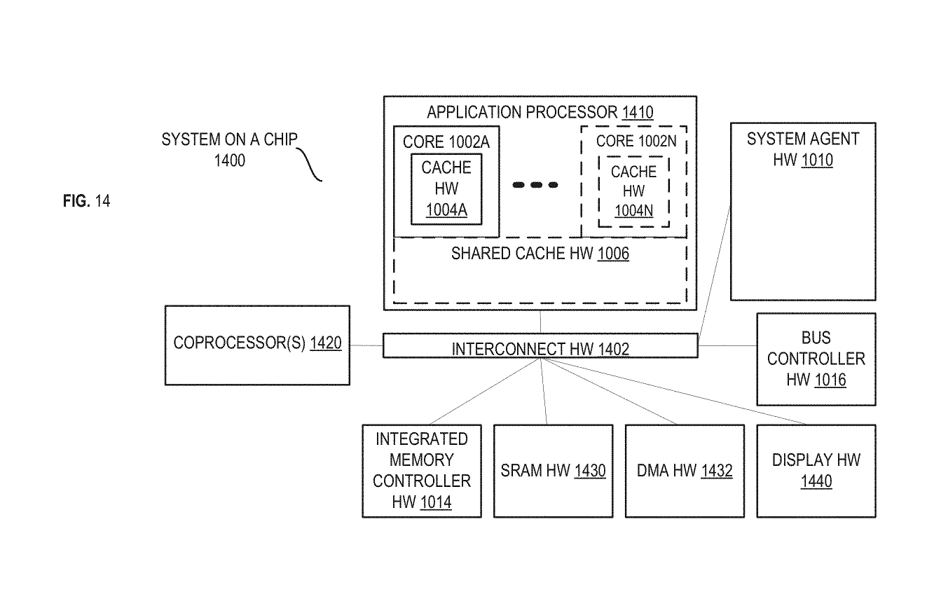

Referring now to FIG. 14, shown is a block diagram of a SoC 1400 in accordance with an embodiment of the present invention. Similar elements in FIG. 10 bear like reference numerals. Also, dashed lined boxes are optional features on more advanced SoCs. In FIG. 14, an interconnect hardware 1402 is coupled to: an application processor 1410 which includes a set of one or more cores 1002A-N and shared cache hardware 1006; a system agent hardware 1010; a bus controller hardware 1016; an integrated memory controller hardware 1014; a set or one or more coprocessors 1420 which may include integrated graphics logic, an image processor, an audio processor, and a video processor; an static random access memory (SRAM) hardware 1430; a direct memory access (DMA) hardware 1432; and a display hardware 1440 for coupling to one or more external displays. In one embodiment, the coprocessor(s) 1420 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1230 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

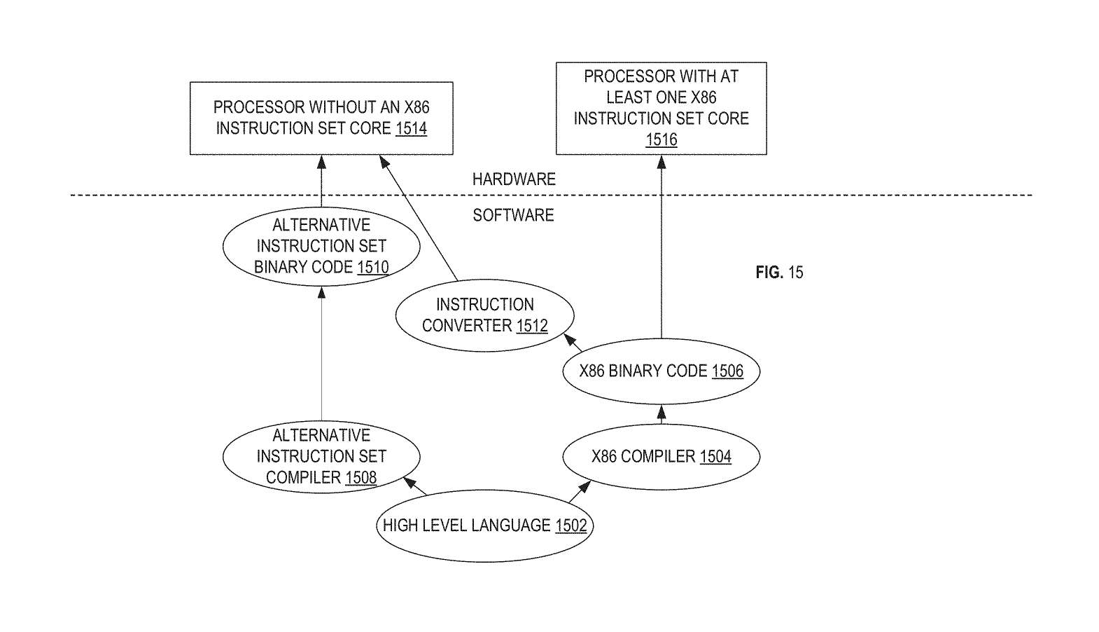

FIG. 15 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 15 shows a program in a high level language 1502 may be compiled using an x86 compiler 1504 to generate x86 binary code 1506 that may be natively executed by a processor with at least one x86 instruction set core 1516. The processor with at least one x86 instruction set core 1516 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1504 represents a compiler that is operable to generate x86 binary code 1506 (e.g., object code) that can, with or without additional linkage processing, be executed on the processor with at least one x86 instruction set core 1516. Similarly, FIG. 15 shows the program in the high level language 1502 may be compiled using an alternative instruction set compiler 1508 to generate alternative instruction set binary code 1510 that may be natively executed by a processor without at least one x86 instruction set core 1514 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1512 is used to convert the x86 binary code 1506 into code that may be natively executed by the processor without an x86 instruction set core 1514. This converted code is not likely to be the same as the alternative instruction set binary code 1510 because an instruction converter capable of this is difficult to make; however, the converted code will accomplish the general operation and be made up of instructions from the alternative instruction set. Thus, the instruction converter 1512 represents software, firmware, hardware, or a combination thereof that, through emulation, simulation or any other process, allows a processor or other electronic device that does not have an x86 instruction set processor or core to execute the x86 binary code 1506.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

1. A processor comprising:
one or more remote registers;
remote register access circuitry to:
detect a request from a requestor to access a first register of the one or more remote registers;
access the first register in accordance to the request without the requestor having to wait for completion of the access; and
provide a notification accessible to the requestor upon completion of the access to the first register of the one or more remote registers.

2. The processor of claim 1, wherein the one or more remote registers are model-specific registers (MSRs).

3. The processor of claim 2, further comprising access detection circuitry to detect the request to access the first register, by monitoring execution circuitry of the processor executing a register-read or register-write instruction.

4. The processor of claim 3, wherein the register-read and register-write instructions are to read a MSR and to write to a MSR, respectively.

5. The processor of claim 1, wherein the requestor is one of a user-level software program, an operating system (OS), and a virtual machine executing on the processor.

6. The processor of claim 1, further comprising status update circuitry to update a status bit in a status register, wherein the status bit corresponds to the first register and is used to indicate whether the access to the first register is complete.

7. The processor of claim 6, wherein a set status bit is an indication that the access to the remote register has not yet completed and an unset status bit is an indication that the access to the remote register is complete.

8. The processor of claim 1, wherein when the request is a write, data is first written into a core register local to the requestor and then delivered to the first register.

9. A method comprising:
detecting a request from a requestor to access a first register of one or more remote registers of a processor;
accessing the first register in accordance to the request without the requestor having to wait for completion of the access; and
providing a notification accessible to the requestor upon completion of the access to the first register of the one or more remote registers.

10. The method of claim 9, wherein the one or more remote registers are model-specific registers (MSRs).

11. The method of claim 10, wherein detecting the request from the requestor to access the first register further comprises monitoring execution circuitry executing a register-read or register-write instruction.

12. The method of claim 11, wherein the register-read and register-write instructions are to read a MSR and to write to a MSR, respectively.

13. The method of claim 9, wherein the requestor is one of a user-level software program, an operating system (OS), and a virtual machine executing on the processor.

14. The method of claim 9, further comprising updating a status bit in a status register, wherein the status bit corresponds to the first register and is used to indicate whether the access to the first register is complete.

15. The method of claim 14, wherein a set status bit is an indication that the access to the remote register has not yet completed and an unset status bit is an indication that the access to the remote register is complete.

16. The method of claim 9, wherein when the request is a write, data is first written into a core register local to the requestor and then delivered to the first register.

17. A system comprising:
a system memory;
a processor comprising one or more remote registers;
remote register access circuitry to:
detect a request from a requestor to access a first register of the one or more remote registers;
access the first register in accordance to the request without the requestor having to wait for completion of the access; and
provide a notification accessible by the requestor upon completion of the access to the first register of the one or more remote registers.

18. The system of claim 17, wherein the one or more remote registers are model-specific registers (MSRs).

19. The system of claim 18, further comprising access detection circuitry to detect the request to access the first register, by monitoring execution circuitry of the processor executing a register-read or register-write instruction.

20. The system of claim 19, wherein the register-read and register-write instructions are to read a MSR and to write to a MSR, respectively.

21. The system of claim 17, wherein the requestor is one of a user-level software program, an operating system (OS), and a virtual machine executing on the processor.

22. The system of claim 17, further comprising status update circuitry to update a status bit in a status register, wherein the status bit corresponds to the first register and is used to indicate whether the access to the first register is complete.

23. The system of claim 22, wherein a set status bit is an indication that the access to the remote register has not yet completed and an unset status bit is an indication that the access to the remote register is complete.

24. The system of claim 17, wherein when the request is a write, data is first written into a core register local to the requestor and then delivered to the first register.
